(19) United States
(12) Patent Application Publication
(10) Pub. No.: US 2004/0172473 A1
(43) Pub. Date: Sep. 2, 2004

(54) Wireless modem simulation of a LAN card

(76) Inventor: Robert M. Lukas, Burnaby (CA)

Correspondence Address: Robert E. Krebs, THELEN REID & PRIEST LLP, P.O. Box 640640, San Jose, CA, 95164-0640, US

(21) Appl. No.: 10/795,024

(22) Filed: Mar. 5, 2004

Related U.S. Application Data
(62) Division of application No. 09/590,769, filed on Jun. 8, 2000.

(51) Int. Cl. G06F 9/455; G06F 15/173

(52) U.S. Cl. 709/226; 703/27

(57) ABSTRACT

An interface apparatus and method facilitates communications on a “connection establishment” type network utilizing the “always connected” type communication techniques thereby eliminating connection establishment steps. The apparatus and method transmits data using the pre-existing “always connected” type application software in the a host computer system's operating system (OS). The interface apparatus intercepts ARP and DHCP service related messages from the host computer's OS and emulates a “always connected” type I/O driver by replying to the service messages with ARP and DHCP service related response messages. As a result, the host computer perceives that the data is being transmitted to another computer system on the same “always connected” type network as the host computer system using a “always connected” type I/O driver. The interface apparatus transmits an ARP message to the host computer's OS which includes an associated address corresponding to a globally unique identification address of the interface apparatus. Perceiving that the associated address is the IP address for its own “always connected” type I/O driver, the host computer system routes the data through the interface apparatus which is then transmitted on the “connection establishment” type network without performing connection establishment steps.

### BACKGROUND OF THE INVENTION

1. Field of the Invention

The present invention relates to wireless device used in distributed computer networks, and particularly to performing communications on a wireless protocol network from a computer system utilizing wireless devices.

2. State of the Art

Conventionally, a wireless modem has been interfaced to a computer system via a serial port (e.g., RS232 serial port) also referred to as the COM port of the computer system. Even in the case in which the modem is embodied on a PC card within a computer system, the modem communicates with the computer on a serial port and appears as a serial port device.

FIG. 1A shows the elements of a typical prior art “connection establishment” type network system. A sender computer system includes operating system (OS) network software having application software for controlling the communication on the network. The sender computer system application software typically sends commands (e.g., Hayes AT commands) to the modem to cause it to dial a remote computer/modem to establish a connection. After the connection is successfully established, data provided from the application software may be transmitted from the sender computer through the network to the destination computer. In an Internet system, the computer system dials to an Internet Service Provider and the data exchanged is in the form of Internet Protocol (IP) packets.

This type of system is categorized as a “connection establishment” type system since some exchange of command and control is required, either manually initiated (e.g., starting a dialer program), or automatically initiated by the operating system (OS) (e.g., the operating system has been previously configured to start the dialer program automatically when an application tries to transmit data) when communicating over the network.

In contrast to the above-described “connection establishment” type system is the “always connected” type system or network. An example of an “always connected” type network is a Local Area Network (LAN) as shown in FIG. 1B. This network utilizes an I/O device or network interface card (NIC) on the computer for transferring data to and from a server on the network. In this technique, interface protocols used to facilitate transmission of data on the LAN network assume that the communication media is always present/always connected and ready to exchange data via packets between the network and the computer. In addition, information for facilitating the transfer of data over the “always connected” type network is contained within packet headers. Consequently, there is no “connection establishment” step required prior to exchanging data. The driver software (application software responsible for interfacing the I/O device to the communication modules in the computer OS) is responsible for providing the “always connected” view of the network.

It should be noted that the network connection link on which “always connected” type communications are transmitted can be a wireless or wired network. In the case of a wireless medium, the same protocols (always on, always connected) are used to facilitate transmission of packets as in the wired network such that no “connection-establishment” step is required by the user even though data is being transmitted wirelessly.

In an “always connected” networked system, certain services are assumed to be present and available on the network. Two essential services that are unique to “always connected” networks (and that are not present or required for “connection establishment” type communications) are the ARP (Address Resolution Protocol) service and the DHCP (Dynamic Host Configuration Protocol) service.

The ARP service allows a computer to discover the low-level addresses needed to communicate directly with other computers in the network. For example, a computer that is connected to a LAN has two addresses: an IP (internet protocol) address that is associated with the computer and a MAC (media access control) address that is associated with the computer's LAN I/O device. Two computers can only exchange data over the LAN if they know each other's MAC address. Since computers identify themselves by their IP address over the network during communications, a method is needed to determine a computer's MAC address. A computer in a LAN network uses the ARP service to find the MAC address of another computer given the target computer's IP address.

The ARP service is employed in a LAN system such that when a sender computer wants to send data to a destination computer, the sender computer broadcasts an ARP request packet with the destination computer's IP address. Upon receiving the ARP request, the destination computer sends an ARP reply with its MAC address. Now the sender can send information to the destination computer directly. To reduce the number of broadcasts, the sender computer stores the IP-MAC address mapping in a cache. Thus, the ARP service is used when the IP-MAC address is not found in the sender computer's cache storage. If the destination IP address belongs to a computer that is not connected to the LAN (i.e., the destination computer is in a different network) the data is directed to a gateway on the LAN. The gateway's MAC address is also determined using the ARP service.

The DHCP service allows a computer newly present on a network to discover and ask the network server for configuration information about itself and about the network. Specifically, a computer that is connected to a LAN which is using a Transmission Control Protocol/Internet Protocol (TCP/IP) protocol suite for setting up/maintaining connections and moving data must be identified by an IP address. The IP address can be permanently assigned and, in this case, must be manually changed if another IP address is to be used. Alternatively, the IP address can be dynamically assigned when the computer boots up. The DHCP service performs this function. In particular, it allows a computer's TCP/IP stack to be dynamically configured with an IP address. In order for the DHCP to work, there must be a DHCP server connected to the LAN. The DHCP server is a computer with the specialized task of managing a finite pool of IP addresses.

The present invention is a technique in which an “always connected” type network model is emulated in a “connection establishment” type network so as to by-pass the “connection establishment” communication step.

### SUMMARY OF THE INVENTION

A wireless interface apparatus and method thereof for facilitating data communications between a remote computer system and a host server on a network utilizing a “connection establishment” type protocol is described. The interface apparatus functions to emulate the operation of an “always connected” type device driver software such that the remote computer's operating system (OS) software perceives that an “always connected” type communication is being performed instead of a “connection establishment” type communication. As a result, communications can be transmitted on the “connection establishment” type network in the same manner as communications are performed on “always connected” type networks, i.e., transparent to the computer system user and without user intervention.

The wireless interface apparatus emulates the operation of a “always connected” type device driver by intercepting “always connected” type messages transmitted from the computer's OS “always connected” type application software and in response, generating “always connected” type messages such that the application software perceives that the communication is being performed with another computer on an “always connected” type network. The wireless apparatus then intercepts the data communications from the computer system and passes them to the computer system I/O device for transmission on the “connection establishment” type network.

In one embodiment, the wireless interface apparatus emulates conventional “always connected” type network services. In one embodiment the services includes the ARP (Address Resolution Protocol) service. In this embodiment, the wireless interface apparatus monitors outgoing traffic from the “always connected” type application software and intercepts ARP requests. The wireless interface apparatus then emulates a “always connected” type I/O driver by replying to the ARP requests with a MAC address which corresponds to a globally unique address corresponding to the wireless interface apparatus. Upon receiving the ARP reply, the “always connected” type application software thinks that the destination computer IP address is on the same “always connected” type network and sends the data communication through the wireless interface apparatus. The data communications are then routed through the wireless interface apparatus and are transmitted onto the “connection establishment” type network.

In another embodiment, the “always connected” type services includes the DHCP (Dynamic Host Configuration Protocol) service and the wireless interface apparatus intercepts DHCP requests. When a DHCP Discover message is intercepted, the wireless interface creates a DHCP Offer which includes an IP address and sends it to the “always connected” type application software. The wireless interface also intercepts the next DHCP Request message and replies by sending a DHCP Ack message to the “always connected” type application software. Thus the wireless interface emulates a DHCP server in order to configure the TCP/IP stack properly within the computer system.

In one embodiment the “always connected” type network is one of a LAN or Internet network.

### BRIEF DESCRIPTION OF THE DRAWINGS

The present invention may be further understood from the following written description in conjunction with the appended drawings. In the drawings:

FIG. 1A shows an example of a prior art “connection establishment” type system;

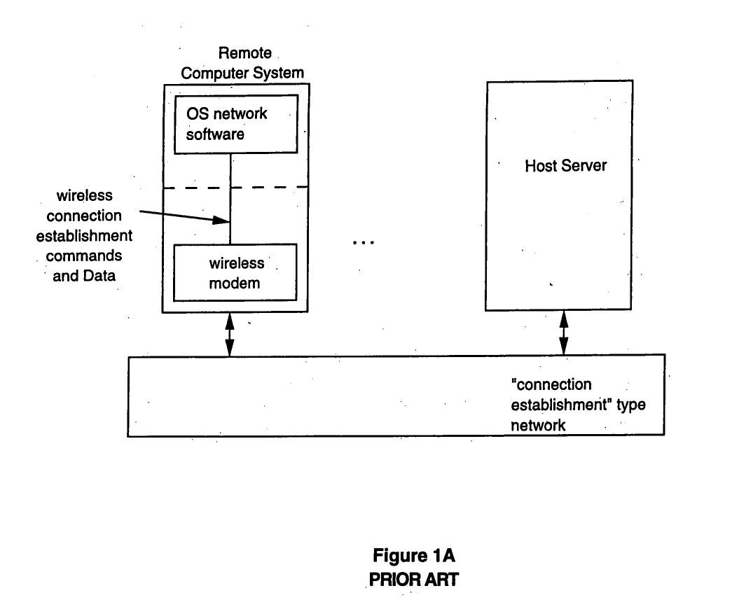

FIG. 1B shows an example of a prior art “always connected” type system;

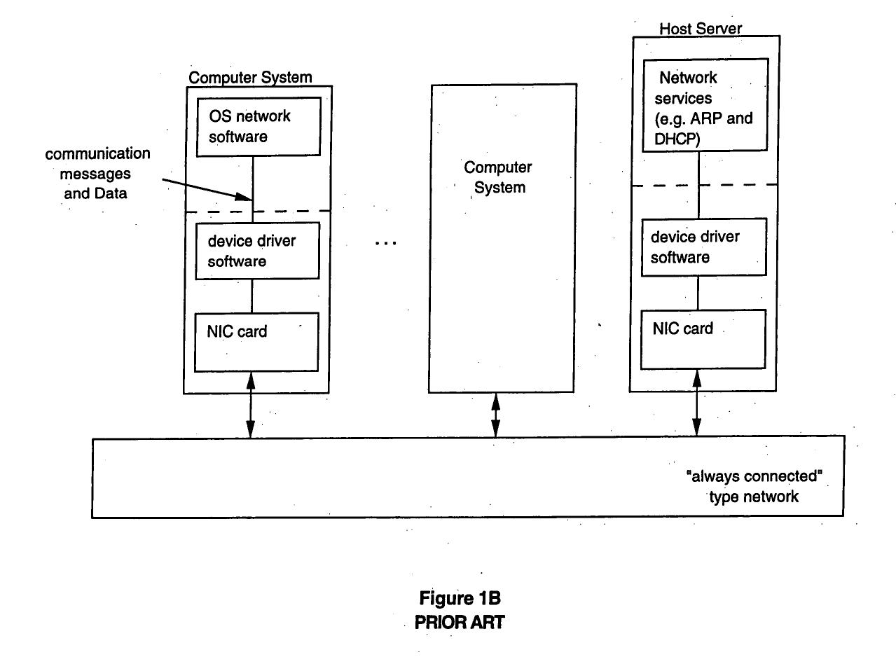

FIG. 2 shows the wireless interface apparatus of the present invention within a remote computer system coupled to a “connection establishment” type network for performing data communications utilizing “always connected” type methodologies; and

FIG. 3 shows one embodiment of the wireless interface apparatus of the present invention.

### DETAILED DESCRIPTION OF THE PREFERRED EMBODIMENTS

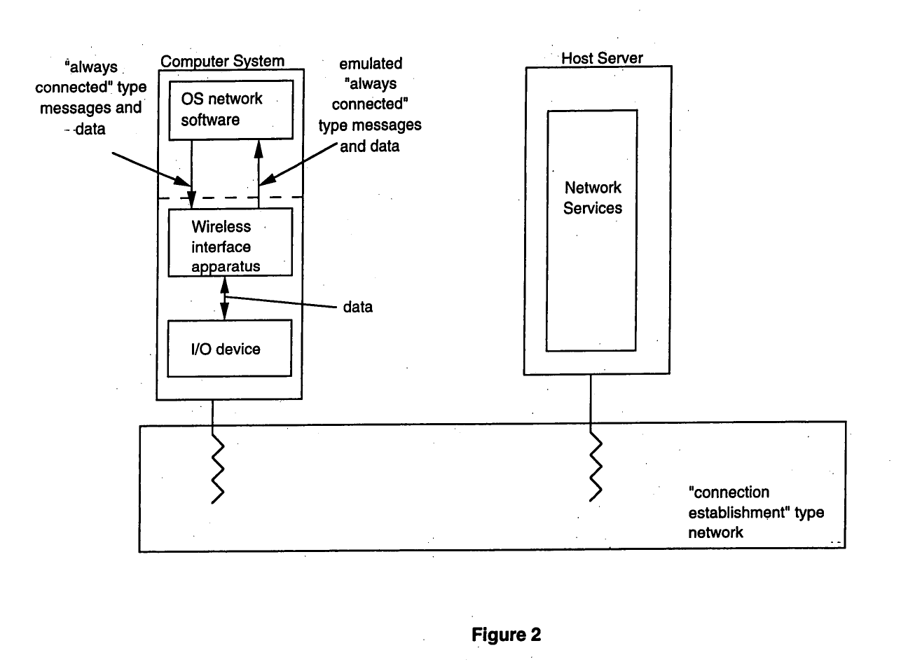

FIG. 2 shows one embodiment of the wireless interface of the present invention in a remote computer system which emulates the operation of a “always connected” type network interface card (NIC) or I/O device within the computer. As a result, the remote computer perceives that it is in an “always connected” type environment connected to other computer systems, when actually the remote computer is connected to a host server over a “connection establishment” communication network.

In one embodiment, the wireless interface apparatus emulates a “always connected” type NIC or I/O device by transmitting “always connected” type service messages to the remote computer's operating system (OS) in response to “always connected” type service messages received from the OS. As a result, the computer's OS passes the data to be transmitted to the interface apparatus of the present invention which is then transmitted on the network.

FIG. 2 shows the wireless interface apparatus receiving “always connected” type communication messages and data to be transmitted from the computer system's application software, and transmitting emulated “always connected” type messages and received data back to the application software.

In operation, the wireless interface apparatus monitors the outgoing signals from the “always connected” type application software. When a “always connected” type service message is detected, the wireless interface responds by generating a corresponding “always connected” type service message back to the application software. Specifically, when an ARP request is intercepted, the wireless interface responds to the intercepted message by generating an ARP reply and sends it back to the application software. The ARP reply includes a MAC address which the application software perceives to be the destination computer's MAC address. However, the MAC address in the ARP reply actually corresponds to a globally unique IP (internet protocol) address of the wireless interface. Upon receiving the ARP reply, since the computer perceives that the destination IP address belongs to a computer system that is on the same “always connected” type network, it routes the data through the wireless interface apparatus. Since, in conventional “always connected” type networks, all data going out to the network passes through the network interface card (NIC) device, the wireless interface apparatus can intercept all data sent by the host computer prior to transmitting it on the network.

In another embodiment, the wireless interface apparatus monitors outgoing signals from the “always connected” type application software to intercept DHCP requests. Specifically, if the DHCP function is enabled in the host computer's TCP/IP stack, the host computer will assume that there is a DHCP server on the “always connected” type network and will send DHCP messages to it. In this embodiment, when a DHCP Discover message is transmitted from the “always connected” type application software to dynamically assign it a IP address, the Discover message is intercepted by the wireless interface apparatus. In response, the wireless interface apparatus of the present invention emulates a DHCP server by creating a DHCP Offer which includes an IP address and sends it to the LAN application software. However, the IP address corresponds to the wireless interface IP address. Perceiving that it is communicating with a DHCP server, the application software next transmits a DHCP Request message, in response to the DHCP Offer. The wireless interface intercepts the DHCP Request message and replies by sending a DHCP Ack message to the application software. The IP address of the wireless interface is used to configure the TCP/IP stack within the host computer system. Hence, the wireless interface emulates a DHCP server in order to configure the TCP/IP stack properly within the computer system.

One advantage of the wireless interface apparatus of the present invention is that it allows a computer system designed to function in a “connection establishment” type environment to work as though it was always-on as in an “always connected” type environment thus eliminating the “connection-establishment” step.

Moreover, it bypasses certain restrictions in commercial OSs (e.g., Windows 95) in which “connections” must be terminated when the computer is placed in standby mode and manually re-established when resuming from standby mode. (It also typically means that applications using those connections must also be stopped and restarted on every power suspend/resume cycle).

In addition, in a conventional “always connected” type system, the I/O device embodied on a PC card is automatically detected upon insertion and the network communication software modules (i.e., application software) are automatically started. However, this is not the case for traditional “connection establishment” type modem PC cards. Hence, by emulating an “always connected” type device driver the wireless interface apparatus win automatically be detected by the communication software and the “always connected” type communication module in the OS will automatically be initiated by the host computer.

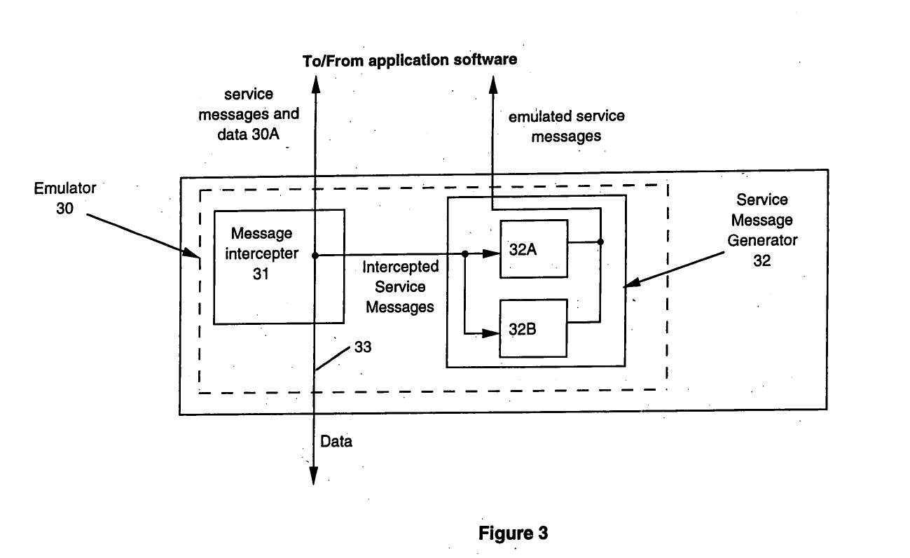

Referring to FIG. 3 the interface apparatus includes an emulator 30 having a message interceptor 31 and “always connected” type service message generator 32. Signal 30A intercepted from the OS application software includes “always connected” type service messages and data transmitted from the “always connected” type application software. Any service messages detected in signal 30A are intercepted by the message interceptor 31 and passed to the service message generator 32. The “always connected” type service message generator generates the appropriate “always connected” type message response and transmits it to the networking software. Due to the emulated messages, data packets from the networking software are also routed to the wireless interface. When the wireless interface detects data packets in signal 30A they are passed through the wireless interface device on bus 33 and to the computer system's I/O device for transmission on the network. In addition, data packets received from the network through the I/O device are passed unmodified back through the wireless interface apparatus on bus 33.

In one embodiment, the “always connected” type service message generator 32 includes an ARP message generator 32A and in another embodiment the LAN message generator includes both an ARP message generator 32A and a DHCP message generator 32B. In this case, ARP messages that are intercepted by interceptor 31 are passed to ARP message generator 32A which, in turn, generates emulated ARP messages. Similarly, DHCP messages that are intercepted are passed to DHCP message generator 32B which, in turn, generates emulated DHCP messages.

Hence, a wireless interface for use with a computer system connected to a “connection establishment” type network is described which facilitates performing communications as though in an “always connected” type communication environment thereby eliminating the connection establishment steps associated with the “connection establishment” type network.

In the preceding description, numerous specific details are set forth in order to provide a thorough understanding of the present invention. It will be apparent, however, to one skilled in the art that these specific details need not be employed to practice the present invention. In other instances, well known communication system structures, operations, and theories have not been described in order to avoid unnecessarily obscuring the present invention.

Moreover, although the components of the present invention have been described in conjunction with certain embodiments, it is appreciated that the invention can be implemented in a variety of other ways. Consequently, it is to be understood that the particular embodiments shown and described by way of illustration is in no way intended to be considered limiting. Reference to the details of these embodiments is not intended to limit the scope of the claims which themselves recite only those features regarded as essential to the invention.

What I claim is:

1. An interface apparatus for performing communications between a remote computer system and a host server over a “connection establishment” type network having an associated “connection-establishment” protocol, said computer system having application software for facilitating “always connected” type communications on a network between said computer system and said server, said apparatus comprising:
a means for emulating the operation of an “always connected” type I/O device driver to said application software during transmission of said communications;
wherein in response to said emulation means said application software functions as though said communications are being transmitted over an “always connected” type network with another computer system utilizing “always connected” type protocol and said communications are transmitted over said “connection establishment” type network without performing connection establishment steps.

2. The apparatus as described in claim 1 wherein said emulation means comprises means for emulating “always connected” type network services.

3. The apparatus as described in claim 2 wherein said emulation means comprises means for intercepting “always connected” type service messages received from said application software and means for generating “always connected” type service messages for transmitting to said application software in response to said received service messages.

4. The apparatus as described in claim 3 wherein “always connected” type network services are ARP services.

5. The apparatus as described in claim 3 wherein said “always connected” type network services are DHCP services.

6. The apparatus as described in claims 4 wherein in response to an ARP message transmitted from said application software said emulation means transmits an ARP message to said application software which includes an associated address corresponding to a globally unique identification address of said apparatus, wherein said host computer perceives said associated address is a destination IP address of another computer system that is on a same “always connected” type network as said computer system, and wherein in response to receiving said ARP message including said associated address, said computer system passes said communication through said apparatus for transmission on said “connection establishment” type network.

7. The apparatus as described in claim 5 wherein in response to an DHCP message transmitted from said application software said emulation means transmits a DHCP message to said application software which includes an associated identifier corresponding to a IP address, wherein said computer system perceives said associated identifier is a dynamically assigned IP address, and wherein in response to receiving said DHCP message including said associated identifier, said associated identifier is assigned to a TCP/IP stack so as to properly configure said TCP/IP stack of said computer system.

8. The apparatus as described in claim 1 wherein said “always connected” type communications are LAN communications and said “always connection” type I/O device driver is a LAN I/O device driver.

9. The apparatus as described in claim 1 wherein said “always connected” type communications are internet type communications and said “always connection” type I/O device driver is an internet type I/O device driver.

10. A method of transmitting communications between a remote computer system and a host server on a network having an associated “connection establishment” type protocol, said computer system having associated application software for facilitating “always connected” type communications, said method comprising the steps of:
initiating a transmission of a communication with said application software;
emulating the operation of an “always connected” type I/O device driver thereby causing said application software to function as though said communications are being transmitted over a network with another computer system utilizing an “always connected” type protocol and causing said application software to pass said communications to a wireless modem apparatus for transmission on said wireless network;
wherein said communications are transmitted over said “connection establishment” type network without performing connection establishment steps.

11. The method as described in claim 10 wherein said step of emulating the operation of an “always connected” type I/O device driver comprises the step of emulating “always connected” type network services.

12. The method as described in claim 11 wherein said step of emulating comprises intercepting “always connected” type network service messages transmitted from said application software and, in response, transmitting “always connected” type network service messages back to said application software.

13. The method as described in claim 12 wherein said “always connected” type network services include ARP services.

14. The method as described in claim 12 wherein said “always connected” type network services include DHCP services.

15. The method as described in claim 13 wherein said step of emulating comprises transmitting an ARP service message to said application software which includes an associated address corresponding to a globally unique identification address of said apparatus in response to an ARP message transmitted from said application software, wherein said host computer perceives said associated address is a destination IP address of another computer system that is on a same “always connected” type network as said computer system thereby causing said communications to be passed to said wireless modem apparatus.

16. The method as described in claim 14 wherein said step of emulating comprises the step of transmitting a DHCP message to said application software which includes an associated identifier corresponding to a IP address in response to an DHCP message transmitted from said application software, wherein said host computer perceives said associated identifier is a dynamically assigned IP address and said associated identifier is assigned to a TCP/IP stack within said computer system.
